(19) United States
(12) Patent Application Publication
(10) Pub. No.: US 2018/0220023 A1
(43) Pub. Date: Aug. 2, 2018

(54) IMAGE SCANNING DEVICE

(71) Applicant: HEWLETT-PACKARD DEVELOPMENT COMPANY, LP., Houston, TX (US)

(72) Inventors: Hai-Long Jacob Wang, Shanghai (CN); Pan-Mi WU, Shanghai (CN); Cheng LI, Shanghai (CN); Yu-Mao ZHU, Shanghai (CN)

(21) Appl. No.: 15/748,581

(22) PCT Filed: Jan. 28, 2016
(86) PCT No.: PCT/CN2016/072501

§ 371 Date: Jan. 29, 2018

(51) Int. Cl. H04N 1/00; G06F 3/12

(52) U.S. Cl. CPC H04N 1/00771; H04N 1/00697; G06F 3/1207; H04N 1/0049; H04N 1/00045; H04N 1/00328; H04N 1/00488; H04N 1/00037

(57) ABSTRACT

A method for generating an alert to enable a user to retrieve a printed document from an image scanning device is described. Multiple portions of a digital image of a printed document obtained through the scan task, are identified. Thereafter, movement of a scan-head assembly of an image scanning device is controlled so as to position the scan-head assembly over a target area of the printed document. The scan-head assembly may be activated to capture a reference image and a series of verification images of the target area of the printed document. Thereafter, the reference image and each of the series of images are compared. Based on the comparison, an alert is generated, wherein the alert is to indicate that the printed document is to be retrieved from the scanning device.

### BACKGROUND

Content on printed documents may be digitized using an image scanning device. The digitized version of the printed documents may be in the form of a file format, which in turn may be used for viewing through a display device or for sharing between different users. In order to digitize the content, one or more printed documents may be placed on the image scanning device. On completion of the image scanning process, a digital image of the printed documents is obtained. The image scanning device may be implemented as a standalone device, such as in the case of flatbed scanner, or may be implemented as part of a multifunction printer that is able to perform additional functions, such as photocopying and faxing.

### BRIEF DESCRIPTION OF THE DRAWINGS

The following detailed description references the drawings, wherein:

FIG. 1 is a block diagram of an example system for generating an alert to enable a user to retrieve a printed document;

FIG. 2 is another block diagram of an example system for generating an alert to enable a user to retrieve a printed document;

FIG. 3 is an example illustration of a target area identified on the printed document;

FIG. 4 is a flowchart of an example method for generating an alert to enable a user to retrieve a printed document;

FIG. 5 is a flowchart of another example method for generating an alert to enable a user to retrieve a printed document; and

FIG. 6 is a block diagram of an example system implementing a non-transitory computer-readable medium, to generating an alert to enable a user to retrieve a printed document.

### DETAILED DESCRIPTION

Printed medium has been one mechanism for distribution of content. The printed content may be made available as a document or in any printed form by which textual or image-based content may be distributed. However, the extent and the amount of information that may be conveyed are limited to the extent to which the printed document itself can be circulated. For example, in order to pass information to individuals multiple copies of the printed document are first obtained and then circulated. Various limitations exist which restrict the extent to which such printed documents (and the information included therein) may be circulated.

Digitization of such printed documents allow storage and distribution of the content of the printed documents. The digitization may be achieved through image scanning devices. Such scanning devices scan the entire printed document to capture a digital image of its content. Based on the captured image, a digital format, i.e., a file format may be generated. The digital format enables viewing of a representation of the printed document (from which the digital format was generated) on a display screen linked to a computing device. The digital format may also be communicated and shared between different users through electronic communication, such as email.

For digitizing, the printed document may be manually placed onto a scan-bed of the image scanning device. Once scanned, the digitized version of the printed document may be shared with an owner of the document via email. In some cases, the digitized version, also referred to as the ‘scan’ of the printed document, may also be stored at a central repository from where the owner may retrieve the scan. In some cases, the owner may inadvertently leave the printed document on the scan-bed. As a result, the printed document may be lost when another individual accidentally disposes the printed document. In certain cases, the printed document may fall in the possession of another individual not designated for accessing the content of such printed document and, therefore, compromising the confidentiality of the information contained therein.

Approaches for generating an alert to enable a user to retrieve a printed document from an image scanning device are described. These approaches may be implemented in any image scanning device, or any in any other systems either incorporating or coupled to image scanning devices. Such image scanning devices may be any device which employ scanning a printed document. The scanning is carried out using a scan-head assembly which is provided with an array of light-based sensors. The sensors of the scan-head assembly capture light reflected off from the surface of the printed document. The light incident on the printed document may be originating from an illuminating source provided within the image scanning device. For scanning, the scan-head assembly may be moved using mechanical components. It should be noted that the image scanning device may also include within its scope other devices employing similar mechanisms as that of a scan-head assembly, without deviating from the scope of the present subject matter. Examples of such other devices include, but are not limited to, photocopy machines.

In order to avoid instances where one or more printed document may be unintentionally left behind on the image scanning device, a determination may be made to ascertain whether a scan task has been completed. A scan task would involve initiating an image scanning device for scanning one or more printed documents, i.e., obtaining a digital image of the printed documents. The digital image thus obtained may be considered as a digitized representation of the printed document. In one example, the scanning of multiple pages may involve the owner interacting with the image scanning device. A scan task in such a case may be considered as complete when the image scanning device does not register any inputs from the owner for continuing a scan, for a prescribed time interval.

The digital image of the printed document may be subsequently processed to identify multiple portions within the digital image. The portions of the digital image may include part of the content, i.e., the content of the printed document. The portions are such that they collectively would form the entire content of the printed document. The content of the multiple portions may be either textual matter, illustrations, images or symbols, or their combination. Once the multiple portions of the printed document are identified, a complexity factor associated with each of the multiple portions is determined. Each of the multiple portions in turn may further include unit segments arranged in an array. In one example, the complexity factor of each of the multiple portions may be based on one or more attributes associated with the respective segments.

Amongst the multiple portions, a portion associated with the highest value of the complexity factor is determined. As the digital image corresponds to the printed document, multiple portions of the digital image in turn would also correspond to physical areas of the printed document. Consequently an area of the printed document corresponding to the portion which is associated with the highest value of the complexity factor is identified.

For such an identified area, referred to as the target area, a corresponding location for the scan-head assembly is determined. Various mechanisms within the image scanning device may be activated to bring the scan-head assembly to the location corresponding to the target area. Once positioned, the scan-head assembly may capture a reference image. If any printed document is still present within the image scanning device, the reference image would include portion of content of the printed document. Thereafter, the scan-head assembly may continue to capture a series of verification images at the location. The scan-head assembly captures the reference image and the verification image without moving from its location. Furthermore, dimension of the reference image and the verification images would depend on the distribution of sensors on the scan-head assembly. Intermittently, each of the captured series of images is compared with the reference image. If the comparison ascertains that the series of the captured verification images matches with the reference image, an alert may be generated to warn the owner that their printed document has been left behind in the image scanning device.

The alert may be generated in the form of a visual or audio indication to draw the attention of the owner to the fact that the printed document is to be removed from the image scanning device. In case the document is still not removed, an indication in the form of an electronic message may be communicated to the owner prompting them to retrieve the document. Thus the present approaches provide mechanisms for preventing instances where owners forget to retrieve their documents from the image scanning device once the scan task has completed. The present approaches may appropriately alert owners in time so that the document which have been left may be retrieved. This further reduces the possibility of the documents being misplaced or accidentally disposed. Furthermore, in cases where the documents include sensitive information, it also may aid in ensuring that the confidentiality of the printed document is maintained.

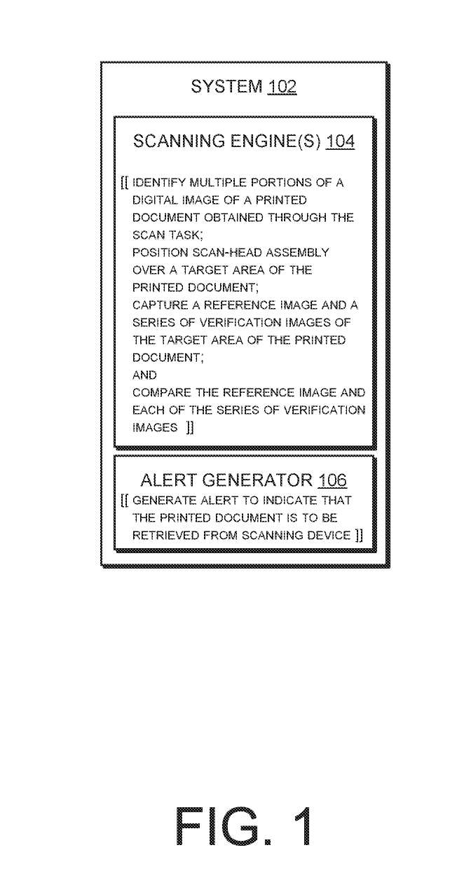

These and other aspects are described in conjunction with one or more computing devices and their operations, as exemplified in FIGS. 1-6. FIG. 1 illustrates an example system 102 to generate an alert to enable a user to retrieve a printed document. In the present example, the system 102 includes scanning engine(s) 104 and alert generator 106. The system 102 may be implemented either as an image scanning device, such as a document scanner, or as a system incorporating such image scanning device, such as a multifunction printer. In one other example, the system 102 may be implemented as processing resource based computing device coupled to an image scanning device. The approaches for generating an alert to enable a user to retrieve a printed document are described, considering that the system 102 implements an image scanning device. However, other possible example implementations, as noted above, would also be within the scope of the present subject matter.

In operation, the scanning engine(s) 104 identifies multiple portions of a digital image. In the present example, the digital image is obtained by digitizing, i.e., scanning a printed document by an image scanning device, for example, the system 102. The multiple portions of the digital image correspond to physical areas of the printed document, which has been scanned. The scanning engine(s) 104 further analyzes each of the multiple portions and identifies a target area of the printed document. In one example, the area of the printed document is identified as the target area based on a complexity factor of its corresponding portion of the digital image. The complexity factor of the portion in turn depends on the content which is included therein. For example, portion of the digital image which includes a picture or an illustration is likely to be more complex as compared to the portion which includes only text-based content. Accordingly, the scanning engine(s) 104 determines a portion of the digital image having the highest value of the complexity factor, and further identifies its corresponding area on the printed document as the target area.

The system 102, on identifying the target area, further determines a scanning location based on the target area. The system 102 subsequently then moves the scan-head assembly to the determined location. The scanning location at which the scan-head assembly is moved to, may be understood as the location at which the scan-head assembly had been present while scanning the printed document. Once brought to the determined location, the scan-head assembly is activated. Upon activation, the scan-head assembly captures a reference image of the area which lies in its field of view. Thereafter, the scan-head assembly further captures a series of verification images while at the scanning location.

As the series of the verification images are captured, the scanning engine(s) 104 compares the reference image with the each of the verification images, as and when they are captured. On comparison, the scanning engine(s) 104 ascertains whether a threshold number of the series of verification images are similar to the reference image. This in turn would imply that any printed document is still present within the system 102 and has not yet been retrieved by its owner. In another example, the scanning engine(s) 104 may compare the reference image with each of the series of images for a specific interval of time without deviating from the scope of the present subject matter. In one example, the fixed time interval after which the reference image and a subsequent verification image are captured and compared may be reduced if the prior comparison yields a match.

Once the scanning engine(s) 104 ascertains that the printed document has not yet been retrieved, the alert generator 106 generates an alert for the owner of the printed document. In one example, the alert may be in the form of a visual or audio indication to draw the attention of the owner that their printed document that has been left behind. If the printed document is still not retrieved, the alert generator 106 further generates communicate the generated alert to the owner along with the digital image of the printed document via electronic means. Examples of such electronic means include, but are not limited to, email.

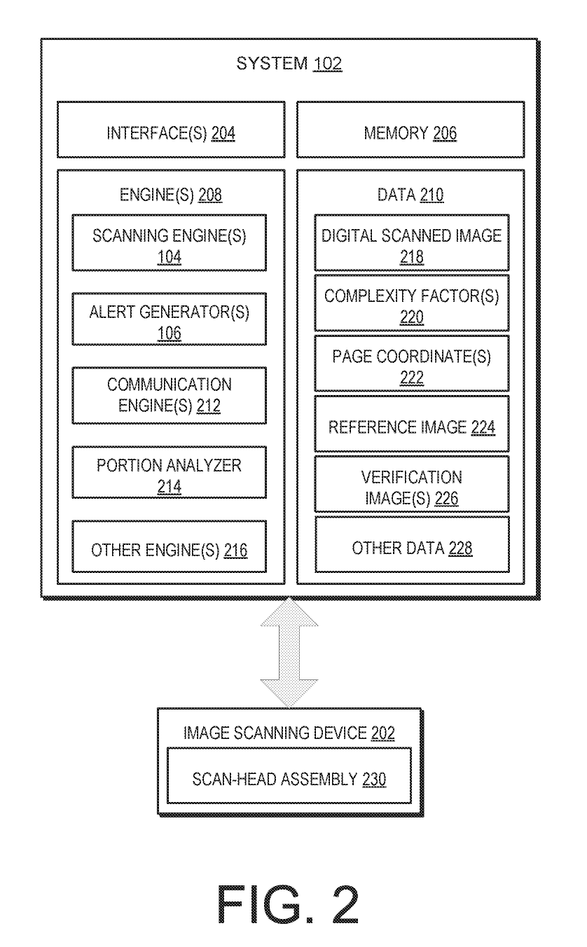

These and other functionalities are provided in further detail in conjunction with FIG. 2. FIG. 2 illustrates an example system 102 to generate an alert to enable a user to retrieve a printed document. The system 102 may be implemented as a standalone computing system communicatively connected through a network to other devices. In the present example, the system 102 is communicatively coupled to an image scanning device 202. Although the image scanning device 202 is illustrated as coupled to the system 102, the image scanning device 202 may be also be implemented within the system 102 without deviating from the scope of the present subject matter. In such cases, the system 102 may be a multifunction printer device capable of performing a wide variety of operations, such as printing, scanning, photocopying, etc.

The system 102 includes interface(s) 204 and memory 206. The interface(s) 204 may include a variety of interfaces, for example, interfaces for data input and output devices, referred to as I/O devices, storage devices, network devices, and the like. The interface(s) 204 facilitate communication between the system 102 and various computing devices connected in a networked environment. In cases where the image scanning device 202 is implemented as a standalone device, the interface(s) 204 may provide an interface for communication between the system 102 and the image scanning device 202.

The memory 206 may store one or more computer-readable instructions, which may be fetched and executed, result in generating an alert to enable a user to retrieve a printed document. The memory 206 may include any non-transitory computer-readable medium including, for example, volatile memory such as RAM, or non-volatile memory such as EPROM, flash memory, and the like. The system 102 further includes engine(s) 208 and data 210.

The engine(s) 208 is implemented as a combination of hardware and programming (for example, programmable instructions) to implement one or more functionalities of the engine(s) 208. In examples described herein, such combinations of hardware and programming may be implemented in a number of different ways. For example, the programming for the engine(s) 208 may be processor executable instructions stored on a non-transitory machine-readable storage medium and the hardware for the engine(s) 208 may include a processing resource (for example, one or more processors), to execute such instructions. In the present examples, the machine-readable storage medium stores instructions that, when executed by the processing resource, implement engine(s) 208. In such examples, the system 102 may include the machine-readable storage medium storing the instructions and the processing resource to execute the instructions, or the machine-readable storage medium may be separate but accessible to system 102 and the processing resource. In other examples, engine(s) 208 may be implemented by electronic circuitry.

The data 210 includes data that is either used or generated as a result of the functionalities implemented by any of the engine(s) 208. In an example, the engine(s) 208 include the scanning engine(s) 104, alert generator 106, communication engine(s) 212, portion analyzer 214, and other engine(s) 216. The other engine(s) 216 may implement functionalities that supplement applications or functions performed by the system 102. Further, the data 210 includes digital scanned image 218, complexity factor value(s) 220, page coordinate(s) 222, reference image 224, target area image(s) 226, and other data 228. As also mentioned previously, the system 102 may be coupled with image scanning device 202. In one example, the image scanning device 202 includes a scan-head assembly 230. The image scanning device 202 may be employed for scanning, i.e., the digitizing a printed document to obtain its digital image.

In operation, the system 102 may implement plurality of functions using any one or more of the engine(s) 208 for generating an alert to enable a user to retrieve a printed document. For example, the scanning engine(s) 104 may determine when any individual, such as the owner of a printed document, has completed the scan task. The scan task is carried out by the image scanning device 202. Once scanned, the image scanning device 202 generates a digital image, i.e., a digital representation of the printed document. The digital image may be of any file format which aids in storing the digital image in a data repository, or for digitally sharing the digital image amongst different users. In the example illustration (i.e., FIG. 2), the digital image is stored as digital scanned image 218.

Once the scan task has been completed, the scanning engine(s) 104 further processes the digital scanned image 218 (i.e., the digital image of the printed document). While processing, the scanning engine(s) 104 identifies one or more portions of the digital scanned image 218. The portions of the digital scanned image 218 is obtained by parsing the data corresponding to the digital scanned image 218. The portions are considered as blocks or contiguous sections of the digital scanned image 218, which when combined together would result in the entire digital scanned image 218. The portions may be identified based on the content which is included in the respective sections. For example, a section of the digital scanned image 218 may include an illustration or may be such that it only includes text-based content. In one example, the scanning engine(s) 104 also determines the relative position of the identified portions of the digital scanned image 218, and store the same as page coordinate(s) 222.

Once the portions of the digital scanned image 218 are identified, the portion analyzer 214 further evaluates a complexity factor for each of the portions. The complexity factor may indicate the extent of content which are present in any given portion. For example, one portion of the digital scanned image 218 may be a picture or illustration, which is considered as complex when compared with another portion which includes only text-based content. For each of the different portions, the portion analyzer 214 determines the complexity factor, which is stored as complexity factor value(s) 220.

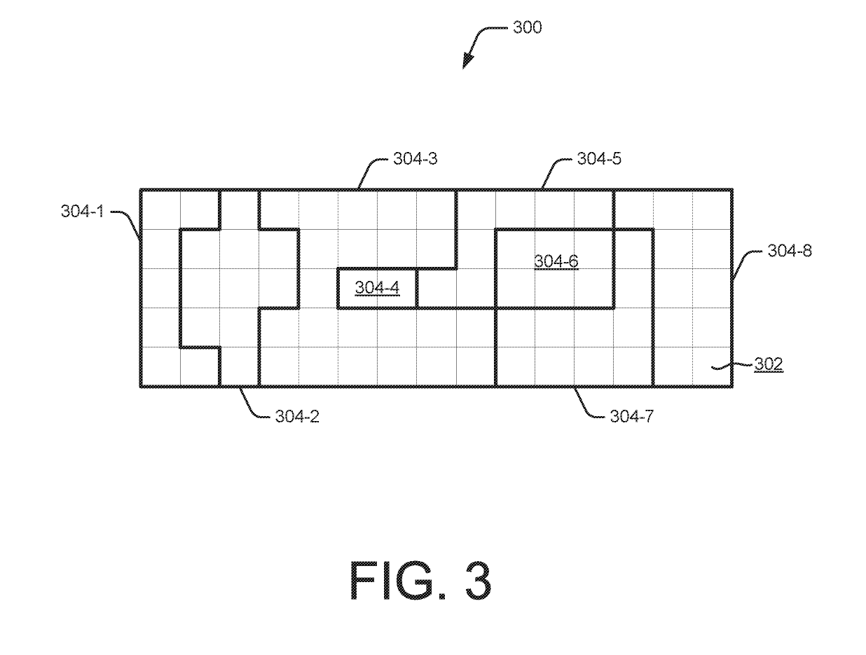

The complexity factor value(s) 220 depends on various attributes corresponding to segments within the respective portions. The manner in which the complexity factor value(s) 220 is determined is explained on conjunction with FIG. 3. FIG. 3 illustrates an example portion 300 of the digital scanned image 218. The portion 300 is presently represented as composed of 5×15 unit blocks, referred to as unit blocks 302. It should be noted that the portion 300 is only exemplary, and should in no way be construed as limiting the scope of the present subject matter. As also described previously, the portion 300 may further include a part of the content of the printed document. Such content may in turn occupy or overlay one or more the unit blocks 302.

The portion analyzer 214 combines one or more unit blocks 302 to form segments 304-1, 2, . . . , 8. The segments 304-1, 2, . . . , 8 may be identified based on one or more attributes which would be associated with each of the blocks 302 forming the respective segments 304-1, 2, . . . , 8. It may be the case that the segment 304-1 is formed of unit blocks 302 which have the same image attributes. Examples of such image attributes include, but are not limited to, brightness, color saturation, contrast, sharpness, etc. For example, segments 304-1 may include unit blocks 302 which have similar levels of brightness or color saturations.

In order to determine complexity factor value(s) 220, the portion analyzer 214 considers the number of unit blocks based on one or more criteria. For example, considering one row of unit blocks 302 to represent a line of content. The portion analyzer 214 initially ascertains which of the segments 304-1, 2, . . . , 8 satisfy a criteria where the segments 304-1, 2, . . . , 8 extend beyond three rows of unit blocks. With the present example, as per FIG. 3, segments 304-1, 2, 3, 7 and 8 would satisfy the given criteria. Once identified, the number of unit blocks 302 which form part of the segments 304-1, 2, 3, 7 and 8 is obtained. The portion analyzer 214 may determine the complexity factor considering the number of blocks 302 within the segments 304-1, 2, 3, 7 and 8. In one example, the complexity factor may be determined by performing a scalar product of the number of blocks 302 present within each of the segments 304-1, 2, 3, 7 and 8. In the manner as described, complexity factor value(s) 220 of each of the portions (such as the portion 300) may be determined. Once determined for all portions of the printed document, the portion analyzer 214 may rank the complexity factor value(s) 220 of each of the portions to determine which portion is associated with the highest of the complexity factor value(s) 220.

As would be understood each of the portions of the digital scanned image 218 corresponds to an actual physical area of the printed document. The portion analyzer 214 identifies the portions with the highest complexity factor value(s) 220. Once identified, the scanning engine(s) 104 then determines a corresponding physical target area of the printed document. In one example, the scanning engine(s) 104 utilizes the page coordinate(s) 222 of the portion with the highest of the complexity factor value(s) 220 to determine the location of the target area. In one example, the location of the portion 300 may also be relied on to determine the location of the target area. For example, a portion which is lying closer to the beginning of the printed document would be preferred when considered with respect to a further lying portion. The beginning of the printed document could be any part of the document which is scanned first by the scan-head assembly 230.

In one example, the scanning engine(s) 104 controls the operation of the scan-head assembly 230. On determination of the location of the target area, the scanning engine(s) 104 generates one or more control instructions for the scan-head assembly 230 of the image scanning device 202. The control instructions are to enable the scanning engine(s) 104 to position the scan-head assembly 230 over the target area.

Once the scan-head assembly 230 is positioned over the target area, the scanning engine(s) 104 further activates the scan-head assembly 230 to capture a reference image of the target area, which is saved as reference image 224. The scanning engine(s) 104 continues to further activate the scan-head assembly 230 to capture a series of images of the target area. The series of images are stored as target area image(s) 226. In the present example, the activation of the scan-head assembly 230 may involve generating control instructions for controlling one or more components of the image scanning device 202. For example, the scanning engine(s) 104 may control an illuminating source (not shown in FIG. 2) of the image scanning device 202 to direct light onto the printed document. The light reflected off the printed document may be then be captured by one or more sensors positioned on the scan-head assembly 230. The sensors, based on the light reflected off the printed document, may generate signals based on which the reference image 224 and the target area image(s) 226 are generated.

While the target area image(s) 226 are being captured by the scan-head assembly 230, the scanning engine(s) 104 may intermittently compare the reference image 224 with each of the target area image(s) 226. Through the comparison, the scanning engine(s) 104 ascertains whether the reference image 224 differs from the target area image(s) 226. If the printed document is still positioned on the image scanning device 202, the target area image(s) 226 would not differ from the reference image 224. On other hand, if the target area image(s) 226 differs from the reference image 224, it may be concluded that the printed document is no longer on the image scanning device 202, and thus, has been retrieved. The capturing of the target area image(s) 226 and the following comparisons with the reference image 224, may be carried out for a specific time interval. In one example, the fixed time interval after which the reference image and a subsequent verification image are captured and compared may be reduced if the prior comparison yields a match. In another example, the scan-head assembly 230 may capture a certain number of target area image(s) 226 which can be compared with the reference image 224.

In one example, if the scanning engine(s) 104 determines that the images are similar, it further determines whether the number of target area image(s) 226 that have been found to be similar exceed a prescribed threshold. There may be a case where the owner removes the printed document while the target area image(s) 226 are being captured. If it is determined that the number does not exceed a prescribed threshold, further number of target area image(s) 226 are captured to ensure that an adequate number of target area image(s) 226 are found to be similar before the owner of printed document is alerted.

In another example, the scanning engine(s) 104 also processes the reference image 224 to determine whether any printed document is in fact positioned on the image scanning device 202. In some cases, the owner of the printed document would retrieve the document prior to the scan-head assembly 230 capturing the reference image 224. In such a case, the scanning engine(s) 104 processes the reference image 224 to check whether the reference image 224 is monotonic (of a consistent image tone) or monochromatic in nature. If the reference image 224 is monotonic or monochromatic, the scanning engine(s) 104 concludes that there is no printed document on the image scanning device 202 before any further processing is carried out.

During the specific time interval or for the certain number of target area image(s) 226, it may be the case that one of the target area image(s) 226 does not match. In such a case, the scanning engine(s) 104 may terminate the further capturing of the target area image(s) 226 and the intermittent comparing of the reference image 224 and the reference image 224. It should be noted that the scenario involving the target area image(s) 226 not matching with the reference image 224 would arise if the printed document has been retrieved from the image scanning device 202. Once terminated, the scanning engine(s) 104 further generates control instructions to move the scan-head assembly 230 of the image scanning device 202 back to its initial starting position.

If, however, each of the target area image(s) 226 match with the reference image 224, the scanning engine(s) 104 concludes that the printed document has not yet been retrieved from the image scanning device 202. On concluding that the printed document has not been retrieved, the alert generator 106 generates one or more alerts. In some circumstances, it is possible that the owner of the printed document is still in the vicinity of the image scanning device 202. The alert generator 106 may generate a series of audio or visual alerts to draw the attention of the owner. For example, the audio alerts may be generated by an audio output device of the image scanning device 202. Similarly, visual alerts may be generated and displayed on a display console coupled to the image scanning device 202.

In another example, the generated alerts may be in the form of an electronic message. Once the electronic alert message is generated, the communication engine(s) 212 may communicate the alert via an electronic communication mechanism such as electronic mail. In one example, communication details for establishing a communication channel with the user may be obtained based on the details shared by the owner for completing a scan task. The electronic alert may then be communicated to the owner, indicating that their printed document has been left behind in the image scanning device 202. It would be understood that the present approaches provide mechanisms by which an alert is generated for a user thereby enabling them to retrieve a printed document that may have been inadvertently left in the image scanning device 202. In such a way, document loss and unwanted dissemination of information may also be avoided.

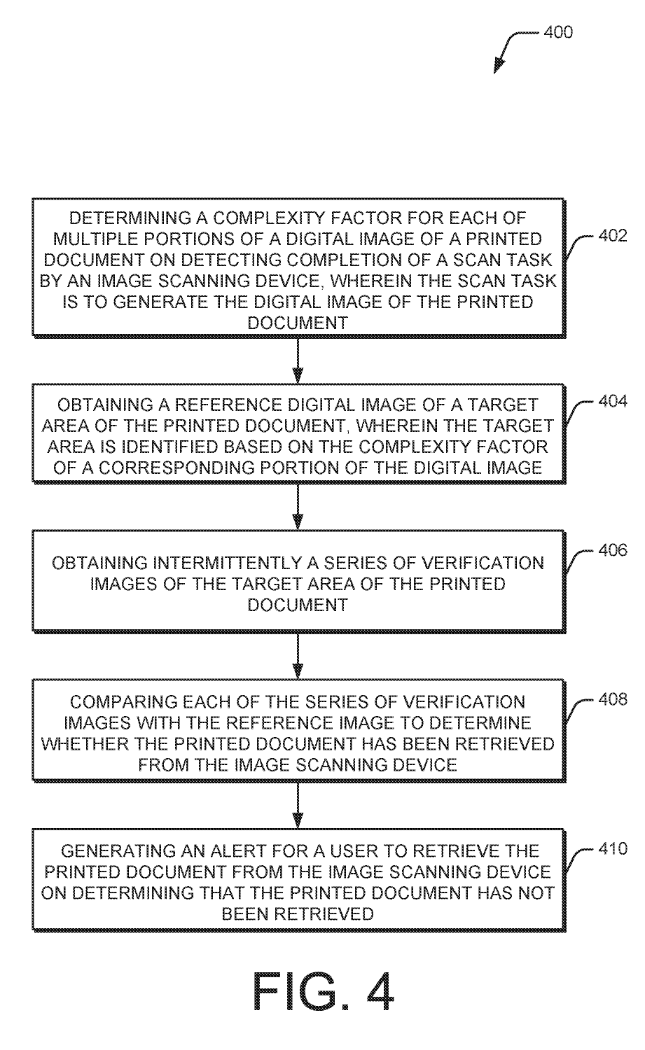

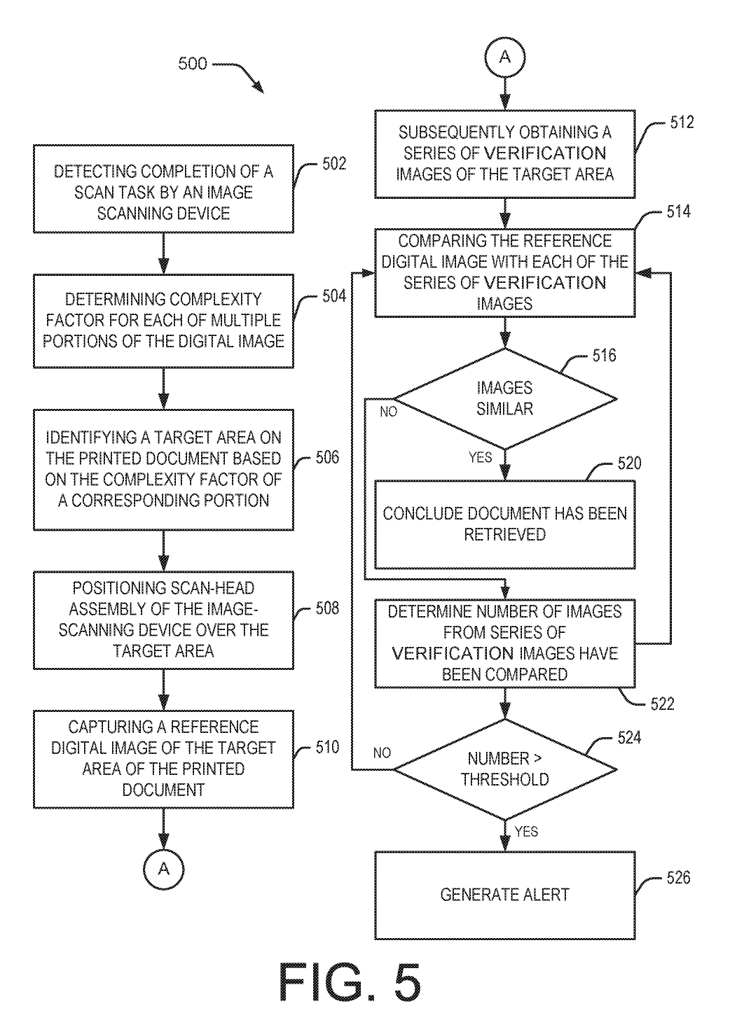

FIGS. 4-5 illustrate example methods 400 and 500, respectively, to generate an alert to enable a user to retrieve a printed document, according to an implementation of the present subject matter. The order in which the methods are described is not intended to be construed as a limitation, and any number of the described method blocks may be combined in any order to implement the aforementioned methods, or an alternative method. Furthermore, methods 400 and 500 may be implemented by processing resource or computing device(s) through any suitable hardware, non-transitory machine readable instructions, or combination thereof.

It may also be understood that methods 400 and 500 may be performed by programmed computing devices, such as system 102 as depicted in FIGS. 1-2. Furthermore, the methods 400 and 500 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 400 and 500 are described below with reference to system 102 as described above; other suitable systems for the execution of these methods may also be utilized. Additionally, implementation of these methods is not limited to such examples.

Returning to FIG. 4, at block 402 a complexity factor for each of multiple portions of a digital image of a printed document is determined. Determining the complexity factor is carried out once a scan task has been completed by the image scanning device. For example, the scanning engine(s) 104 determines when an individual has completed the scan task, by monitoring whether digital scanned image 218 of the printed document is obtained. The scan task may be carried out by the image scanning device 202. In another example, the portion analyzer 214 determines the complexity factor value(s) 220 of the different portions of the printed document.

At block 404, a reference digital image of a target area of the printed document is obtained. The target area in turn is identified based on the complexity factor of the corresponding portions of the printed document. For example, the scanning engine(s) 104 obtains the complexity factor value(s) 220 as evaluated by the portion analyzer 214. Once obtained, the scanning engine(s) 104 further identifies the portion which is associated with the highest complexity factor value(s) 220. Corresponding to the portion with associated with the highest of the complexity factor value(s) 220, the scanning engine(s) 104 may identify an area on the printed document as the target area. With the target area identified, scan-head assembly 230 of the image scanning device 202 may be positioned over the target area for capturing a reference image. In one example, the reference image is stored as reference image 224.

At block 406, a series of digital images of the target area are obtained. For example, the scan-head assembly 230 is further activated to capture a series of images. Each of the images are of the target area, are stored as target area image(s) 226. In one example, the scan-head assembly 230 continues to capture the target area image(s) 226 till a certain number is obtained, or continue to capture the target area image(s) 226 for a specific time interval. In one example, the fixed time interval after which the reference image and a subsequent verification image are captured and compared may be reduced if the prior comparison yields a match.

At block 408, each of the series of images are compared with the reference image. For example, the scanning engine(s) 104 may intermittently compare the reference image 224 with each of the target area image(s) 226, as and when, they are captured. A match between the reference image 224 and all of the target area image(s) 226 would indicate that the printed document has not been retrieved by the owner. On the other hand, any of the target area image(s) 226 not matching with the reference image 224 would indicate that the printed document may have been retrieved by the owner from the image scanning device 202.

At block 410, on determining that the printed document has not been retrieved, an alert is generated for the owner. The alert serves as an indication for the owner that the printed document has been left behind. For example, the scanning engine(s) 104 on determining that the printed document has been left behind, further activates the alert generator 106 to generate one or more alerts. The alerts may be in the form of visual or audio indications generated by output devices associated with the image scanning device 202. In one example, the alerts generated by the alert generator 106 may be communicated to the owner via electronic means by the communication engine(s) 212.

FIG. 5 provides another example method 500 for generating an alert to enable a user to retrieve a printed document. At block 502, completion of a scan task is detected. In one example, the scanning engine(s) 104 may detect whether a scan task has been completed. As would be understood, a scan task may be carried out using device, such as image scanning device 202. Once the scan task is completed, the image scanning device 202 may generate a digital scanned image 218 of the printed document. In the present example, the scanning engine(s) 104 may determine that a scan task is completed when the digital scanned image 218 of the printed document is generated.

At block 504, a complexity factor for plurality of portions of the digital image is obtained. For example, the portion analyzer 214 may calculate a complexity factor for each of the portions of the digital scanned image 218. The complexity factor may indicate the extent of complexity of the content included within any given portion. As would be understood, a picture or illustration would be considered as complex when compared only text-based content. For each of the different portions, the portion analyzer 214 determines the complexity factor, which may be stored as complexity factor value(s) 220. In one example, the portion analyzer 214 determines the complexity factor value(s) 220 based on segments and unit block which may be forming a portion, such as the portion 300. The portion analyzer 214 may identify one or more segments 304-1, 2, . . . , 8 may be identified based on one or more attributes which would be associated with the blocks 302 which form the respective segments 304-1, 2, . . . , 8. Based on attributes of segments 304-1, 2, . . . , 8, the portion analyzer 214 may calculate the complexity factor value(s) 220 of all the portions of the digital scanned image 218.

At block 506, a target area of the printed document is identified based on the complexity factors of the corresponding digital image. For example, the scanning engine(s) 104 may determine a corresponding physical target area of the printed document. To that end, the scanning engine(s) 104 may utilize the page coordinate(s) 222 of the portion with the highest of the complexity factor value(s) 220 to determine the location of the target area.

At block 508, a scan-head assembly of the image scanning device is positioned over the identified target area. For example, the scanning engine(s) 104 may generate one or more control instruction which when executed control movement of the scan-head assembly 230 of the image scanning device 202. As a result of the control instructions, the scan-head assembly 230 is moved and positioned such that its field of view includes the target area of the printed document. As would be understood, the scan-head assembly 230 moves in a direction which generally lies orthogonal to the length of the printed document which has been scanned.

At block 510, a reference image of the printed document is captured by the scan-head assembly. For example, the scan-head assembly 230 of the image scanning device 202 may be activated to capture an image of the target area. Such an image may be stored as reference image 224. For capturing the reference image 224, one or more light sources within the image scanning device 202 may be activated to illuminate the printed document placed on the image scanning device 202. The incident light reflected off the printed document is received by sensors on the scan-head assembly 230 to generate the reference image 224.

At block 512, a series of digital images of the target area is captured. For example, the scan-head assembly 230 may capture a series of images of the target area, once the reference image 224 has been obtained. The series of images, i.e., target area image(s) 226 may be captured in the same manner as that of the reference image 224. In one example, a certain number of target area image(s) 226 are captured. In another example, the target area image(s) 226 are captured for a specific time duration.

At block 514, the reference image and the target area images are compared with each other. For example, the scanning engine(s) 104 may compare the reference image 224 and each of the target area image(s) 226. The comparison of such types of images may be carried out using technique generally understood. In one example, the scanning engine(s) 104 may compare one or more attributes of the reference image 224 and the target area image(s) 226.

At block 516, it is ascertained whether the reference image and the target area images are similar. For example, the scanning engine(s) 104 may compare the reference image 224 and each of the target area image(s) 226 to determine if the images are similar. The images being similar would indicate that the printed document has not been retrieved from the image scanning device 202. On the other hand, if the reference image 224 and the target area image(s) 226 are found to be similar, it may be concluded that the document has been left behind. Returning to the present method, on determining that the images are similar (‘No’ path from block 516), the scanning engine(s) 104 may conclude that the printed document has been removed. In such a case, the scan-head assembly 230 may be reinitialized and the image scanning device 202 may be prepared for performing the next scan task (block 518).

If however, the scanning engine(s) 104 determines that one or more of the target area image(s) 226 are similar to the reference image 224 (‘Yes’ path from block 516), the scanning engine(s) 104 may further determine whether the number of target area image(s) 226 that have been found to be similar exceed a prescribed threshold. The present step may detect that the printed document has been removed before any alert is generated (block 522). If at block 522, it is determined that the number does not exceed a prescribed threshold (‘No’ path from block 522), the process may further proceed back to block 514 to further ensure that an adequate number of target area image(s) 226 are found to be similar before the owner of printed document is alerted.

If the number of target area image(s) 226 that have been compared does exceed the prescribed value (‘Yes’ path from block 522), the scanning engine(s) 104 may activate the alert generator 106. The alert generator 106 may generate one or more alerts which may be in the form of audio or visual alerts to draw the attention of the owner. In another example, the generated alerts may in the form of an electronic message. Once the electronic alert message is generated, the communication engine(s) 212 may communicate the alert via an electronic communication mechanism such as electronic mail. In this manner, the owner of the printed document may be appropriately informed that their printed document has been left behind, so that it may be retrieved in a timely manner to avoid any subsequent loss.

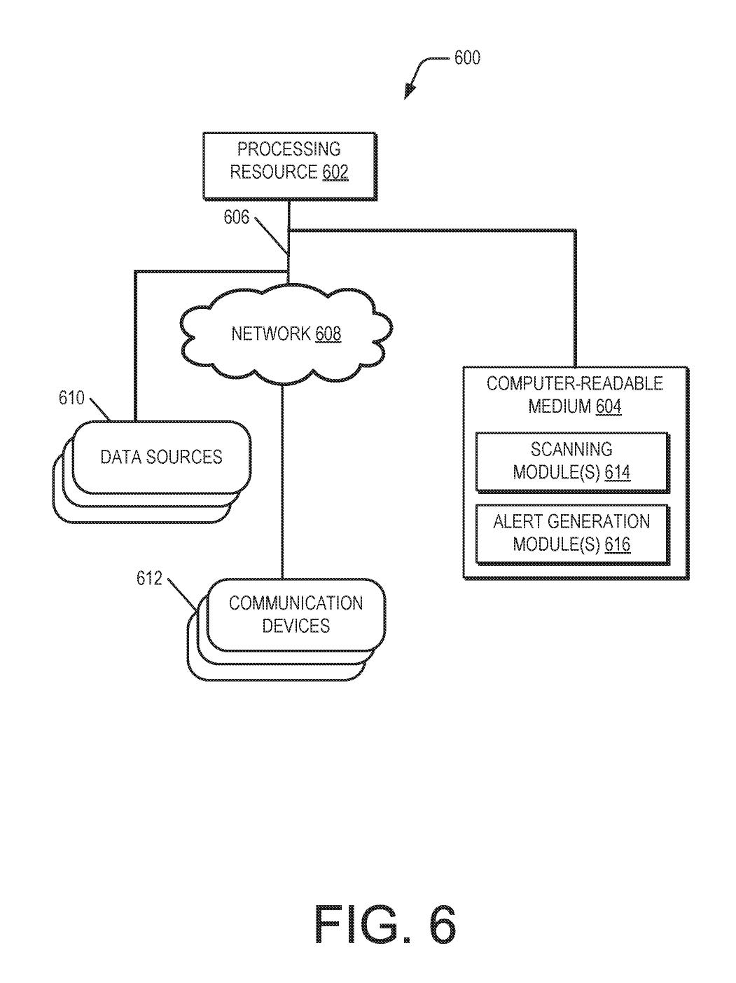

FIG. 6 illustrates a system environment 600 for generating an alert to enable a user to retrieve a printed document, according to an example of the present disclosure. The system environment 600 may comprise at least a portion of a public networking environment or a private networking environment, or a combination thereof. In one implementation, the system environment 600 includes a processing resource 602 communicatively coupled to a computer readable medium 604 through a communication link 606.

For example, the processing resource 602 can include one or more processors of a computing device for generating an alert to enable a user to retrieve a printed document. The computer readable medium 604 may be, for example, an internal memory device of the computing device or an external memory device. In one implementation, the communication link 606 may be a direct communication link, such as any memory read/write interface. In another implementation, the communication link 606 may be an indirect communication link, such as a network interface. In such a case, the processing resource 602 can access the computer readable medium 604 through a network 608. The network 608 may be a single network or a combination of multiple networks and may use a variety of different communication protocols.

The processing resource 602 and the computer readable medium 604 may also be coupled to data sources 610 through the communication link 606, and/or to communication devices 612 over the network 608. The coupling with the data sources 610 enables in receiving the data in an offline environment, and the coupling with the communication devices 612 enables in receiving the data in an online environment.

In one implementation, the computer readable medium 604 includes a set of computer readable instructions, implementing a scanning module(s) 614 and an alert generation module(s) 616. The instructions implementing scanning module(s) 614 may, in one example, be executable code for generating an alert to enable a user to retrieve a printed document. The set of computer readable instructions within medium 604 may be accessed by the processing resource 602 through the communication link 606 and subsequently executed to process data communicated with the data sources 610 in order for generating an alert to enable a user to retrieve a printed document.

In operation, the scanning module(s) 614 may identify multiple portions of a digital image. The digital image in turn is obtained by digitizing, i.e., scanning a printed document by an image scanning device, for example, image scanning device 202 (as depicted in FIG. 2). The digital image may be stored in a storage repository, such as digital scanned image 218 within the system 102. The multiple portions of the digital image correspond to physical areas of the printed document, which has been scanned. Each of the multiple portions are analyzed to identify a target area of the printed document. In one example, the area of the printed document may be identified as target area based on a complexity factor of its corresponding portion of the digital image. As an example, the complexity factor may be stored as complexity factor value(s) 220.

The complexity factor, such as the complexity factor value(s) 220, of the portion in turn may depend on the content which is included therein. For example, portion of the digital image which may include a picture or an illustration is likely to be more complex as compared to the portion which includes only text-based content. Accordingly, a portion (e.g., portion 300) of the digital image having the highest value of the complexity factor may be determined, and its corresponding area of the printed document is identified as the target area.

The scanning module(s) 614, on identifying the target area, may determine a scanning location based on the target area. The scanning module(s) 614 may subsequently move the scan-head assembly, such as the scan-head assembly 230 of the image scanning device 202, to the determined location. The scanning location at which the scan-head assembly 230 is moved to may be understood as the location at which the scan-head assembly 230 had been present while scanning the printed document. Once brought to the determined location, the scan-head assembly 230 may be activated. Upon activation, the scan-head assembly 230 may capture a reference image 224 of the area which lies in its field of view. Thereafter, the scan-head assembly 230 may capture a series of images, referred to as target area image(s) 226, while at the scanning location.

As the target area image(s) 226 are captured, the scanning module(s) 614 may compare the reference image 224 with the each of the target area image(s) 226, as and when they are captured. On comparison, the scanning module(s) 614 may ascertain that a threshold number of the target area image(s) 226 are similar to the reference image 224. This in turn would imply that any printed document is still present within the image scanning device 202, and has not yet been retrieved by its owner. In another example, the scanning module(s) 614 may compare the reference image 224 with each of the target area image(s) 226 for a specific interval of time without deviating from the scope of the present subject matter.

Once the scanning module(s) 614 ascertains that the printed document has not yet been retrieved, the alert generation module(s) 616 generates an alert for the owner of the printed document. In one example, the alert may be in the form of a visual or audio indication to draw the attention of the owner that their printed document that has been left behind. If the printed document is still not retrieved, the alert generation module(s) 616 may communicate the generated alert to the owner along with the digital image of the printed document via electronic means. Examples of such electronic means include, but are not limited to, email.

Although examples for the present disclosure have been described in language specific to structural features and/or methods, it should stood that the appended claims are not necessarily limited to the specific features or methods described. Rather, the specific features and methods are disclosed and explained as examples of the present disclosure.

We claim:

1. A method comprising:
determining a complexity factor for each of multiple portions of a digital image of a printed document upon detecting completion of a scan task by an image scanning device, wherein the scan task is to generate the digital image of the printed document;
obtaining a reference digital image of a target area of the printed document, wherein the target area is identified based on the complexity factor of a corresponding portion of the digital image;
obtaining intermittently a series of verification images of the target area of the printed document;
comparing each of the series of verification images with the reference image to determine whether the printed document has been retrieved from the image scanning device; and
generating, upon determining that the printed document has not been retrieved, an alert for a user to retrieve the printed document from the image scanning device.

2. The method as claimed in claim 1, wherein, for identifying the target area of the printed document the method further comprises:
comparing the complexity factor of each of the multiple portions of the digital image of the printed document with a threshold;
selecting a portion, from amongst the multiple portions, for which the complexity factor is greater than the threshold; and
correlating the portion with the target area on the printed document being scanned by the image scanning device.

3. The method as claimed in claim 1, wherein the target area is identified based on its physical proximity from a reset position of a scan-head of the image scanning device.

4. The method as claimed in claim 1, wherein each of the comparing is performed after a fixed time interval.

5. The method as claimed in claim 1, further comprising:
determining that the printed document has not been retrieved on ascertaining that the reference image and each of the series of verification images subsequently captured are similar.

6. The method as claimed in claim 4, wherein, upon ascertaining that the reference image and at least one of the series of verification images are similar, the method comprises reducing the fixed time interval after which to intermittently compare the reference image and a subsequent verification image in the series of verification images.

7. The method as claimed in claim 1, wherein the alert is generated after a number of the series of verification images have been compared with the reference image.

8. A system comprising:
a scanning engine to,
identify multiple portions of a digital image of a printed document obtained through the scan task;
control movement of a scan-head assembly of an image scanning device to position the scan-head assembly over a target area of the printed document, wherein the target area is identified based on a corresponding portion selected from among the multiple portions of the digital document;
capture a reference image and a series of verification images of the target area of the printed document; and
compare the reference image and each of the series of verification images;
an alert generator coupled to the scanning engine, wherein the alert generator is to,
generate an alert based on the comparing of the reference image and each of the series of the verification image, wherein the alert is to indicate that the printed document is to be retrieved from the scanning device.

9. The system as claimed in claim 8, further comprising a communication engine, wherein the communication engine is to:
establish a communication channel with a user associated with the scan task; and
communicate the generated alert to the user through the communication channel.

10. The system as claimed in claim 8, further comprising a portion analyzer to:
evaluate a complexity factor for each of the multiple portions of the digital image of the printed document;
determine perpendicular distance of each of a plurality areas of the printed document corresponding to each of the multiple portions from an originating position of the scan-head assembly; and
identify one from the plurality of areas as the target area based on the complexity factor and the perpendicular distances of each of the plurality of areas.

11. The system as claimed in claim 8, wherein to compare the reference image and each of the series of images, the scanning engine is to further:
based on the comparing, ascertain whether the reference image and each of the series of verification images of the target area are similar; and
on ascertaining the series of verification images to be similar to the reference image, initiate the alert generator to generate the alert.

12. The system as claimed in claim 8, wherein the scanning engine is to:
capture the series of verification images of the target area after a time interval less than 200 milliseconds; and
compare a captured image of the target area with the reference image prior to capturing a subsequent verification image in the series of verification images.

13. The system as claimed in claim 10, wherein the portion analyzer to evaluate the complexity factor, is to further:
determine segments within each of the multiple portions of the printed;
further determine attributes associated with the segments; and
based on extent of coverage of the segments within each of the multiple portions, evaluate the complexity factor.

14. A non-transitory computer-readable medium comprising instructions executable by a processing resource to:
on detecting completion of the scan task, obtain a complexity factor for each of multiple portions of the digital image of a printed document;
capture a reference digital image of a target area of the printed document, wherein the target area is identified based on the complexity factor of a corresponding portion of the digital image;
further capture a series of verification images of the target area of the printed document;
compare each of the series of verification images with the reference image to determine whether the printed document has been retrieved from the image scanning device; and
generate an alert for a user to retrieve the printed document from the image scanning device on determining that the printed document has not been retrieved.

15. The computer-readable medium as claimed in claim 14, wherein the complexity factor is obtained based on extent of coverage of segments within each of the multiple having common attributes.
